(19) United States
(12) Patent Application Publication
(10) Pub. No.: US 2013/0167073 A1
(43) Pub. Date: Jun. 27, 2013

(54) SMART AND FLEXIBLE LAYOUT CONTEXT MANAGER

(71) Applicants: Nati Ari, Zoran (IL); Vladimir Tkach, Netania (IL)

(72) Inventors: Nati Ari, Zoran (IL); Vladimir Tkach, Netania (IL)

(73) Assignee: SAP Portals Israel Ltd., a German corporation

(21) Appl. No.: 13/403,592

(22) Filed: Feb. 23, 2012

Related U.S. Application Data
(63) Continuation of application No. 13/335,543, filed on Dec. 22, 2011.

(51) Int. Cl. G06F 3/048

(52) U.S. Cl. 715/798; 715/799

(57) ABSTRACT

The present disclosure involves computer-implemented methods, software, and systems for intuitive widget ordering in a workspace. A computer-implemented method includes loading a container widget, rendering, using at least one computer, a layout grid associated with the loaded container widget, and receiving an action associated with the container widget.

### CROSS-REFERENCE TO RELATED APPLICATION

This application is a continuation of U.S. patent application Ser. No. 13/335,543 entitled “Smart and Flexible Layout Context Manager” filed on Dec. 22, 2011, the disclosure of which is hereby incorporated by reference.

### TECHNICAL FIELD

The present disclosure relates to computer-implemented methods, software, and systems for intuitive widget ordering in a workspace.

### BACKGROUND

Dashboard workspaces allow information to be displayed through visually rich and personalized organizational layouts through the use of one or more widgets. A user can analyze and track a large amount of complex, changing, and often real-time information in an efficient manner using widgets in a workspace arranged in a logical orientation for the user or according to a predetermined orientation. This approach to presenting data leads to many possible issues, such as overlap of widgets if a widget is moved from its position in the workspace, the need to resize other widgets upon resizing a widget to avoid occluding data, and the inability to automatically and/or efficiently sort widgets in the workspace according to defined rules. Efficient handling of widgets in the workspace is essential for efficient and cost-effective use and management of the workspace, the widgets, and the often critical information presented through the use of the workspace.

### SUMMARY

The present disclosure relates to computer-implemented methods, software, and systems for intuitive widget ordering in a workspace. One computer-implemented method includes loading a container widget, rendering, using at least one computer, a layout grid associated with the loaded container widget, and receiving an action associated with the container widget.

While generally described as computer-implemented software embodied on a non-transitory computer readable storage device that processes and transforms respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example system for intuitive widget ordering in a workspace.

FIG. 2 is a flowchart illustrating initial layout grid rendering/subsequent user actions.

FIG. 3A is a flowchart illustrating a pre-fetching function for a widget.

FIG. 3B is a block diagram illustrating the selection and addition of a widget to a container widget.

FIG. 4A is a flowchart illustrating functionality for handling overlapping widgets.

FIGS. 4B-4C are block diagrams illustrating example widget overlap scenarios handled by an overlapping widget organizer function.

FIG. 5A is a flowchart illustrating the functionality to remove empty layout grid row space between widgets.

FIG. 5B is a block diagram illustrating the removal of empty layout grid row space between widgets.

FIG. 6A is flow chart illustrating functionality for modifying the grid layout in a containing widget when the containing widget is resized.

FIG. 6B is block diagram illustrating modifying the grid layout in a containing widget when the containing widget is resized.

FIG. 7 is a block diagram illustrating an example grid layout and associated widgets within a container widget.

FIG. 8 is a block diagram illustrating the maximization of a widget within a container widget.

Like reference numbers and designations in the various drawings indicate like elements.

### DETAILED DESCRIPTION

The disclosure generally describes computer-implemented methods, software, and systems for intuitive widget ordering in a workspace. Specifically described is a workspace layout grid and associated algorithms to intuitively order widgets in the workspace through the use of the workspace layout grid.

The advantages of the present disclosure are numerous. First, a moving a widget within a workspace will result in automatic arrangement of overlapped widgets in order to preclude occluding of data and to eliminate the need to manually rearrange a workspace widget arrangement. Second, resizing a widget will also result in the automatic resizing of overlapped widgets in order to keep all widgets visible within the workspace. Third, widgets can be efficiently sorted based on criteria such as alphanumeric determination, timestamp, permissions, etc. Fourth, prediction of a size for a widget can be determined based upon widget-displayable content and other widget's dimensions and locations can be adjusted accordingly. Finally, workspace user satisfaction is enhanced. Other advantages will be apparent to those skilled in the art.

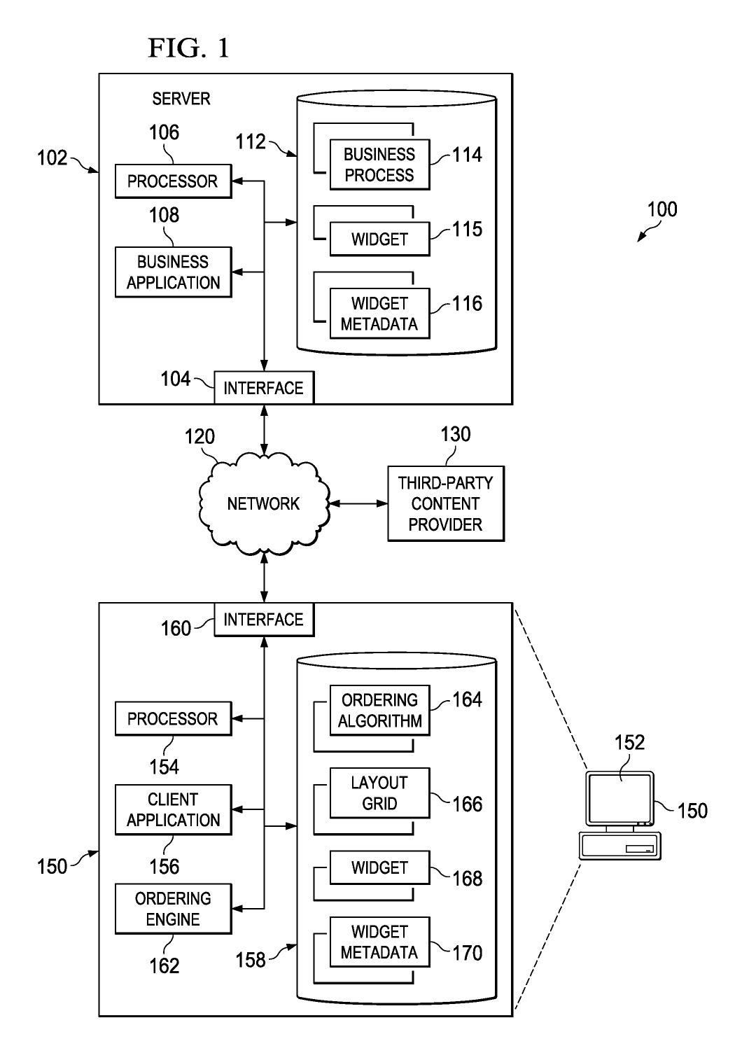

Turning to the figures, FIG. 1 illustrates an example environment 100 for supporting intuitive widget ordering in a workspace in accordance with one implementation of the present disclosure. The illustrated environment 100 includes, or is communicably coupled with, a server 102, a network 120, a third-party content provider 130, and a client 150. Environment 100 may represent a non-ERP system or an ERP system integrating internal and external management information across an entire organization and enabling the flow of information between all business functions inside boundaries of the organization and manages connections to outside stakeholders to the organization. The server 102, the third-party content provider 130, and the client 150 may communicate across or via network 120. In general, example environment 100 depicts an example configuration of a system for intuitive widget ordering in a workspace. In alternative implementations, the elements illustrated within the server 102, the third-party content provider 130, and the client 150 can be included in or associated with different and/or additional servers, clients, networks, or locations other than those illustrated in FIG. 1. Additionally, the functionality associated with any component illustrated in example environment 100 may be associated with any suitable system, including by adding additional instructions, programs, applications, or other software to existing systems. For example, the components illustrated within the server 102 may be included in multiple servers, cloud-based networks, or other locations accessible, either directly or via network 120, to the server 102.

In general, the server 102 is any server that provides support to the client 150 for intuitive widget ordering in a workspace using at least one business process 114 instance, at least one widget 115 instance, and at least one widget metadata 116 instance. In other implementations, the server can also provide support to the client 150 using at least a business application 108 and the at least one business process 114 instance, the at least one widget 115 instance, and the at least one widget metadata 116 instance. Although illustrated as residing locally to server 102, the at least one business process 114 instance, the at least one widget 115 instance, and the at least one widget metadata 116 instance may reside either locally or remote to the server 102. Although FIG. 1 illustrates a single server 102, example environment 100 can be implemented using any number of servers.

For example, each server 102 may be a Java 2 Platform, Enterprise Edition (J2EE)-compliant application server that includes Java technologies such as Enterprise JavaBeans (EJB), J2EE Connector Architecture (JCA), Java Messaging Service (JMS), Java Naming and Directory Interface (JNDI), and Java Database Connectivity (JDBC). In some implementations, other non-Java based servers and or systems could be used for the server 102. In some implementations, each server 102 can store and execute a plurality of various other applications (not illustrated), while in other implementations, each server 102 can be a dedicated server meant to store and execute a particular business application 108 and related functionality. In some implementations, the server 102 can comprise a Web server or be communicably coupled with a Web server, where the particular business application 108 associated with that server 102 represents a Web-based (or Web-accessible) application accessed and executed on an associated client 150 to perform the programmed tasks or operations of the corresponding business application 108. In still other instances, the business application 108 can be executed on a first system, while the business application 108 manipulates and/or provides information for data located at a remote, second system (not illustrated).

At a high level, the server 102 comprises an electronic computing device operable to receive, transmit, process, store, or manage data and information associated with the example environment 100. The server 102 illustrated in FIG. 1 can be responsible for receiving application requests from a client 150 (as well as any other entity or system interacting with the server 102), responding to the received requests by processing said requests in an associated business application 108 and sending the appropriate responses from the business application 108 back to the requesting client 150 or other requesting system. The business application 108 can also process and respond to local requests from a user locally accessing the associated server 102. Accordingly, in addition to requests from the external clients 150 illustrated in FIG. 1, requests associated with a particular business application 108 may also be sent from internal users, external or third-party customers, as well as any other appropriate entities, individuals, systems, or computers. In some implementations, the business application 108 can be a Web-based application executing functionality associated with the networked or cloud-based business process.

As used in the present disclosure, the term “computer” is intended to encompass any suitable processing device. For example, although FIG. 1 illustrates a single server 102, example environment 100 can be implemented using any number of servers, as well as computers other than servers, including a server pool. Indeed, the server 102 may be any computer or processing device such as, for example, a blade server, general-purpose personal computer (PC), Macintosh, workstation, UNIX-based workstation, tablet computer, or any other suitable device. In other words, the present disclosure contemplates computers other than general purpose computers, as well as computers without conventional operating systems. Further, the illustrated server 102 may be adapted to execute any physical or virtual operating system, including Linux, UNIX, Windows, Mac OS, WebOS, iOS, Android, or any other suitable operating system.

In the illustrated implementation of FIG. 1, the server 102 includes an interface 104, a processor 106, a business application 108, and a memory 112. While illustrated as a single component in the example environment 100 of FIG. 1, alternative implementations may illustrate the server 102 as comprising multiple or duplicate parts or portions accordingly.

The interface 104 is used by the server 102 to communicate with other systems in a client-server or other distributed environment (including within example environment 100) connected to the network 120 (e.g., an associated client 150, as well as other systems communicably coupled to the network 120). FIG. 1 depicts both a server-client environment, but could also represent a cloud-computing network. Various other implementations of the illustrated example environment 100 can be provided to allow for increased flexibility in the underlying system, including multiple servers 102 performing or executing at least one additional or alternative implementation of the business application 108, as well as other applications (not illustrated) associated with or related to the business application 108. In those additional or alternative implementations, the different servers 102 can communicate with each other via a cloud-based network or through the connections provided by network 120. Returning to the illustrated example environment 100, the interface 104 generally comprises logic encoded in software and/or hardware in a suitable combination and operable to communicate with the network 120. More specifically, the interface 104 may comprise software supporting at least one communication protocol associated with communications such that the network 120 or the interface's hardware is operable to communicate physical signals within and outside of the illustrated example environment 100.

Generally, the server 102 may be communicably coupled with a network 120 that facilitates wireless or wireline communications between the components of the example environment 100, that is the server 102 and the client 150, as well as with any other local or remote computer, such as additional clients, servers, or other devices communicably coupled to network 120, including those not illustrated in FIG. 1. In the illustrated example environment 100, the network 120 is depicted as a single network, but may be comprised of more than one network without departing from the scope of this disclosure, so long as at least a portion of the network 120 may facilitate communications between senders and recipients. In some implementations, at least one component associated with the server 102 can be included within the network 120 as at least one cloud-based service or operation. The network 120 may be all or a portion of an enterprise or secured network, while in another implementation, at least a portion of the network 120 may represent a connection to the Internet. In some implementations, a portion of the network 120 can be a virtual private network (VPN). Further, all or a portion of the network 120 can comprise either a wireline or wireless link. Example wireless links may include cellular, 802.11a/b/g/n, 802.20, WiMax, and/or any other appropriate wireless link. In other words, the network 120 encompasses any internal or external network, networks, sub-network, or combination thereof operable to facilitate communications between various computing components inside and outside the illustrated example environment 100. The network 120 may communicate, for example, Internet Protocol (IP) packets, Frame Relay frames, Asynchronous Transfer Mode (ATM) cells, voice, video, data, and other suitable information between network addresses. The network 120 may also include at least one local area network (LAN), radio access network (RAN), metropolitan area network (MAN), wide area network (WAN), all or a portion of the Internet, and/or any other communication system or systems in at least one location. The network 120, however, is not a required component in some implementations of the present disclosure.

As illustrated in FIG. 1, the server 102 includes a processor 106. Although illustrated as a single processor 106 in the server 102, two or more processors may be used in the server 102 according to particular needs, desires, or particular implementations of example environment 100. The processor 106 may be a central processing unit (CPU), a blade, an application specific integrated circuit (ASIC), a field-programmable gate array (FPGA), or another suitable component. Generally, the processor 106 executes instructions and manipulates data to perform the operations of the server 102 and, specifically, the functionality associated with the corresponding business application 108. In one implementation, the server 102 processor 106 executes the functionality required to also receive and respond to requests and instructions from the client 150.

Regardless of the particular implementation, “software” may include computer-readable instructions, firmware, wired or programmed hardware, or any combination thereof on a tangible and non-transitory medium operable when executed to perform at least the processes and operations described herein. Indeed, each software component may be fully or partially written or described in any appropriate computer language including C, C++, C#, Java, Visual Basic, assembler, Perl, any suitable version of a 4GL, as well as others. It will be understood that while portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components, as appropriate. In the illustrated example environment 100, each processor 106 executes the business application 108 stored on the associated server 102. In other implementations, a particular server 102 can be associated with the execution of two or more business applications 108 as well as at least one distributed application (not illustrated) executing across two or more servers 102.

A business application 108 is illustrated within the server 102 and may operate to execute business process-related events associated with at least one business process. Although illustrated as a single business application 108 in the server 102, two or more business applications 108 may be used in the server 102 according to particular needs, desires, or particular implementations of example environment 100. The business application 108 can be any application, program, module, process, or other software that may execute, change, delete, generate, or otherwise manage information associated with a particular server 102, particularly with respect to executing business process-related events associated with at least one business process. In particular, business processes communicate with other users, applications, systems, and components to send and receive events. In some implementations, a particular business application 108 can operate in response to and in connection with at least one request received from an associated client 150. Additionally, a particular business application 108 may operate in response to and in connection with at least one request received from other business applications 108, including a business application 108 associated with another server 102. In some implementations, each business application 108 can represent a Web-based application accessed and executed by remote clients 150 via the network 120 (e.g., through the Internet, or via at least one cloud-based service associated with the business application 108). For example, a portion of a particular business application 108 may be a Web service associated with the business application 108 that is remotely called, while another portion of the business application 108 may be an interface object or agent bundled for processing at a remote client 150. Moreover, any or all of a particular business application 108 may be a child or sub-module of another software module or enterprise application (not illustrated) without departing from the scope of this disclosure. Still further, portions of the particular business application 108 may be executed or accessed by a user working directly at the server 102, as well as remotely at a corresponding client 150. In some implementations, the server 102 can execute the business application 108. In some implementations, the business application 108 can be executed via a client 150 accessing the business application 108.

The server 102 also includes a memory 112 for storing data and program instructions. The memory 112 may include any memory or database module and may take the form of volatile or non-volatile memory including, without limitation, magnetic media, optical media, random access memory (RAM), read-only memory (ROM), flash memory, removable media, or any other suitable local or remote memory component. The memory 112 may store various objects or data, including classes, widgets, frameworks, applications, backup data, business objects, jobs, Web pages, Web page templates, database tables, process contexts, repositories storing services local to the server 102, and any other appropriate information including any parameters, variables, database queries, algorithms, instructions, rules, constraints, or references thereto associated with the purposes of the server 102 and an associated business application 108. In some implementations, including a cloud-based system, some or all of the memory 112 can be stored remote from the server 102, and communicably coupled to the server 102 for usage. As illustrated in FIG. 1, memory 112 includes the at least one business process 114 instance, the at least one widget 115 instance, and the at least one widget metadata 116 instance.

The at least one widget 115 instance may represent a part of a GUI, made up of a collection of a number of GUI elements, such as a checkboxes, pull-down lists, buttons, etc., that allows a computer user to control and change the appearance of the GUI elements for operating a software application within a workspace. For example, the at least one widget 115 instance may be a network browser interface, a dialog box interface, an email application interface, a mobile device application interface, or other suitable part of a GUI. For the purposes of this disclosure, a “workspace” means a GUI environment, such as a computer desktop or within and application window, such as a browser, in which other widgets are displayed and/or manipulated. Note that a computer desktop may itself be considered a widget in that a computer desktop widget may be used to allow computer users to display and control various software applications, computer functions, etc. within the computer desktop widget. The at least one widgets 115 instance may contain and/or display various types of data, such as graphs, images, audio, video, or other suitable data, whether local or from a third-party content provider.

In some implementations, metadata associated with the at least one widget 115 instance can be stored with the widget 115 instance. The metadata may include, for example, type, name, title, language, resolution, dimension, optimum dimension, minimum dimension, maximum dimension, color, configuration, container, location, editability, security permissions, sub-components, layout grid dimension, layout grid granularity, layout grid column gap space, layout grid row gap space, or other suitable data value. Not all metadata types will apply to all widgets. In some implementations, only the applicable metadata will be associated with a widget. In other implementations, all metadata types can be associated with a widget with inapplicable metadata types given a value, such as NULL, to indicate they are not applicable to the widget. For example, if a particular computer desktop widget is the highest level widget possible, the particular computer desktop widget may have metadata establishing the resolution of the computer desktop as 1900×1080 pixels and a container value equal to NULL since nothing contains it. A user may be able to use the computer desktop widget and associated functionality in order to change the resolution metadata value to, for example, 1280×1024 pixels. In another example, a browser widget, when the browser widget is closed, may update a dimension metadata value to a current dimension of the browser widget, for example, a value of 900×600 pixels within the particular computer desktop widget resolution of 1280×1024. When the browser widget is re-started in the particular computer desktop widget, the browser widget may display itself with a dimension of 900×600 pixels after accessing the dimension metadata value. In other implementations, the metadata can be stored separately, either partially or completely, from the at least one widget 115 instance.

The third-party content provider 130 provides third-party content for consumption by the server 102 and/or the client. For example, a particular widget 115 instance may make a request for third-party content with which to populate the particular widget before the particular widget 115 instance is transmitted in response to a network request for the particular widget 115. Although illustrated as remote from server 102 and client 150, the third party content provider 130 may be incorporated into the server 102 and/or client 150 without departing from the scope of this disclosure as long as content from the third-party content provider 130 is available to some or all of the elements of example environment 100 via at least network 120.

In general, a client 150 is any computer device operable to connect or communicate with server 102 using a wireless or wireline connection (i.e., network 120). In particular, the client 150 may be embodied as a mobile or non-mobile computing device. At a high level, each client 150 can include a processor 154, a GUI 152, a client application 156, a memory 158, an interface 160, and an ordering engine 166. In general, the client 150 comprises an electronic computer device operable to receive, transmit, process, and/or store any appropriate data associated with it, a server 102, or other suitable data source.

The GUI 152 of the client 150 is operable to allow the user of the client 150 to interface with at least a portion of the system 100 for any suitable purpose, including to allow a user of the client 150 to interact with at least one client application 156, business application 108, and ordering engine 162. In particular, the GUI 152 may provide users of the client 150 with a visualized representation of the client application 156, business application 108, ordering engine 162, and other client 150 functionality. The GUI 152 may include a plurality of user interface elements such as interactive fields, pull-down lists, buttons, and other suitable user interface elements operable at the client 150.

In some implementations, processor 154 can be similar to processor 106 of the server 102. In other implementations, the processor 154 may be a processor designed specifically for use in client 150. Further, although illustrated as a single processor 154, the processor 154 may be implemented as multiple processors in the client 150. Regardless of the type and number, the processor 154 executes instructions and manipulates data to perform the operations of the client 150, including operations to receive and process information from the server 102 or other suitable data source, access data within memory 158, execute the client application 156 and/or ordering engine, as well as perform other operations associated with the client 150.

A client application 156 is illustrated within the client 150 and may operate to, among other things, support intuitive widget ordering in a workspace. Although illustrated as a single client application 156 in the client 150, two or more client applications 156 may be used in the client 150 according to particular needs, desires, or particular implementations of example environment 100. The client application 156 can be any application, program, module, process, or other software that may execute, change, delete, generate, or otherwise manage information associated with a particular client 150. In some implementations, a particular client application 156 can operate in response to and in connection with at least one request received from the client 150. Additionally, a particular client application 156 may operate in response to and in connection with at least one request received from other client applications 156, including a client application 156 associated with another client 150. In some implementations, the client-application 156 can use parameters, metadata, and other information received at launch to access a particular set of data from the server 102, including the at least one business process 114 instance, the at least one widget 115 instance, and the at least one widget metadata 116 instance. Once a particular client application 156 is launched, a user may interactively process a task, event, or other information associated with the client 150 or the server 102. The client application 156 may retrieve information from one or more servers 102 or one or more clients 150. Further, the client application 156 may access a locally-cached set of client-application-related information (not illustrated) stored on the client 150. In some implementations, each client application 156 can represent a Web-based application accessed and executed by clients 150 or servers 102 via the network 120 (e.g., through the Internet, or via at least one cloud-based service associated with the business application 108). For example, a portion of a particular client application 156 may be a Web service associated with the client application 156 that is remotely called, while another portion of the client application 156 may be an interface object or agent bundled for processing at a remote client 150. Moreover, any or all of a particular client application 156 may be a child or sub-module of another software module (not illustrated) without departing from the scope of this disclosure. Still further, portions of the particular client application 156 may be executed or accessed by a user working directly at the client 150, as well as remotely at a separate client 150, a server 102, or other computer (not illustrated).

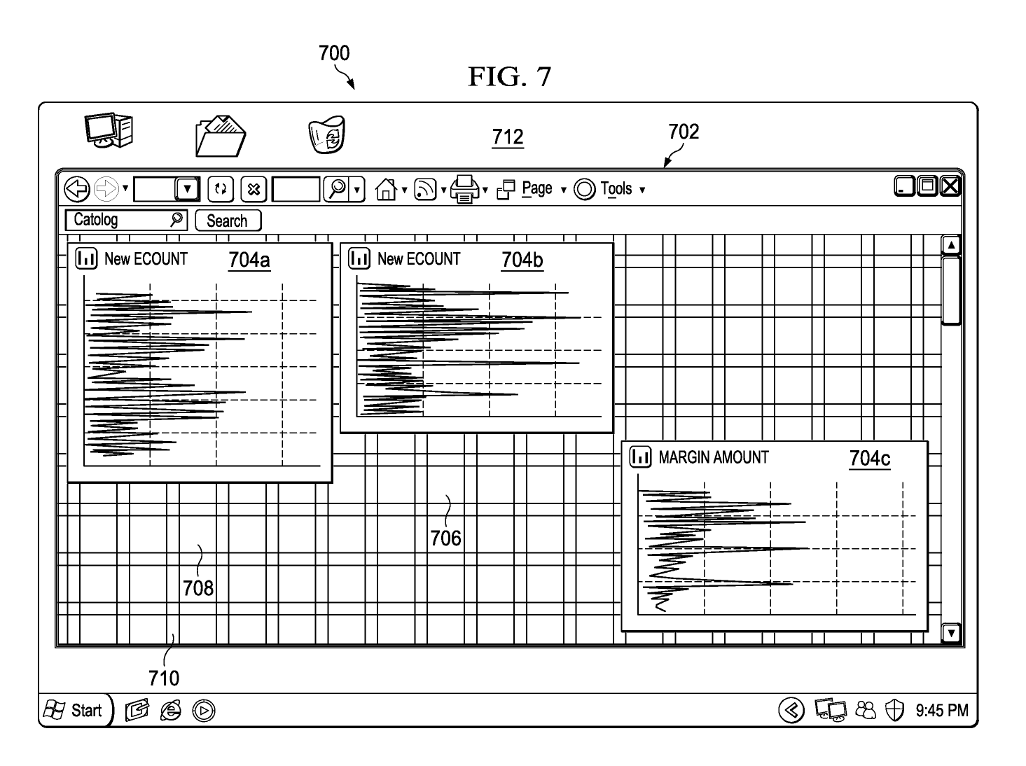

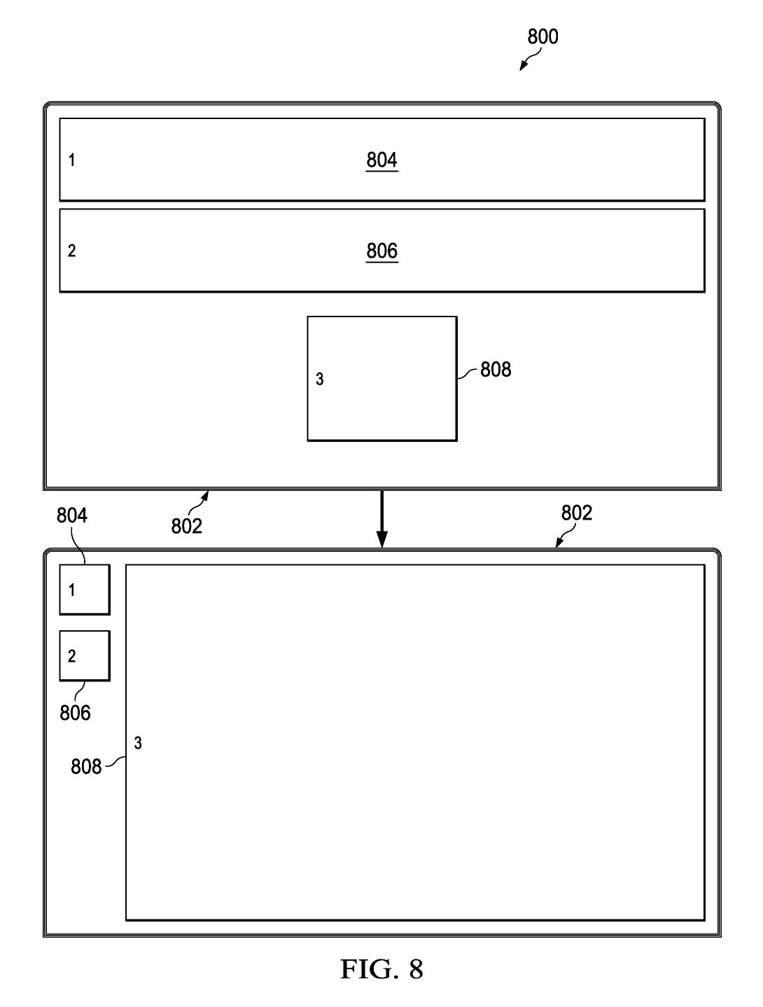

The at least one layout grid 166 instance may be established within each widget instance that may contain (i.e., a “container” widget) another widget instance and act as a framework to mount and/or align widgets within the container widget. In some implementations, the ordering engine instantiates the at least one layout grid 116 instance and manipulates the at least one layout grid 116 instance. In some implementations, the at least one layout grid 166 can be a stand-alone widget and act as a container widget. For example, referring now to FIG. 7, on a computer desktop 712, a browser widget 702 containing a layout grid 706 is shown as a container for three widgets, widgets 704a-704c, arranged within the layout grid 706. In some implementations, the at least one layout grid 166 instance can be invisible, while in other implementations, the at least one layout grid 166 instance can visible. In various implementations, a user can select whether the at least one layout grid 166 instance is visible or invisible. In some implementations, the at least one layout grid 166 instance has an established dimension (i.e., columns and rows). Returning to FIG. 7, the layout grid dimension is approximately 18×8, respectively) with a cell 708 defined at the intersection of each column and row. In some implementations, widgets conform themselves dimensionally to the closest dimension to fit entirely within the defined boundary of a column and row (i.e., widgets will not partially fill a cell of a column and/or a row). For example, widgets 704a-704c are shown conformed to the layout grid 706. In other implementations, widgets can partially fill cells of columns and/or rows of the layout grid 706. In some implementations, columns and rows can have a gap space 710 between the column and row boundaries. In some implementations, the gap space 210 is automatically determined. In other implementations, the gap space 710 is user selectable. Although cell 708 is illustrated in FIG. 7 as being square in shape, in some implementations, cells can be rectangular or some other suitable shape.

In some implementations, metadata associated with the at least one layout grid 166 instance can be stored with the at least one layout grid 166 instance. The metadata may include, for example, dimension, optimum dimension, minimum dimension, maximum dimension, container, location, editability, security permissions, granularity, column gap space, row gap space, or other suitable data value. In other implementations, the metadata can be stored separately, either partially or completely, from the at least one layout grid 166 instance.

The at least one layout grid 166 instance also has a granularity. Returning to FIG. 7, The granularity reflects how many columns and rows exist in the layout grid 706 for a specific area. In some implementations, the granularity is automatically calculated based upon, for example, a computer desktop widget resolution metadata value, a maximum dimension metadata value, or some other suitable metadata value. For example, for a desktop resolution of 1280×1024, the granularity metadata for the browser widget 702 may specify “1 column, every 70 pixels, 1 row, every 128 pixels.” Various operations and algorithms with respect to using the layout grid 706 are described in detail below.

An ordering engine 162 is illustrated within the client 150 and may operate to intuitively order widgets in a workspace using the at least one layout grid 166 instance. Although illustrated as a single ordering engine 162 in the client 150, two or more ordering engines 110 may be used in the client 150 according to particular needs, desires, or particular implementations of example environment 100. The ordering engine 162 can be any application, program, module, process, or other software that may execute, change, delete, generate, or otherwise manage information associated with a particular client 150, particularly with respect to intuitive widget ordering in a workspace. In some implementations, a particular ordering engine 162 can operate in response to and in connection with at least one request received from the client 150 or an associated server 102. Additionally, a particular ordering engine 162 may operate in response to and in connection with at least one request received from other ordering engines 110 and client applications 156, including an ordering engine 162 and client application 156 associated with another client 150. The particular ordering engine 162 may also respond to GUI events generated by various widgets, such as, resize events, movement events, and other suitable GUI events, whether local or remote. In some implementations, each ordering engine 162 can represent a Web-based application accessed and executed by the client 150. In some implementations, all or a portion of a particular ordering engine 162 can be a Web service associated with the ordering engine 162. In some implementations, all or a portion of the ordering engine 162 can be an interface object or agent bundled for processing. Moreover, any or all of a particular ordering engine 162 may be a child or sub-module of another software module (not illustrated) without departing from the scope of this disclosure. Still further, all or portions of the particular ordering engine 162 may be executed or accessed by a user working directly at the client 150, as well as remotely at a separate client 150, a server 102, or other computer (not illustrated).

The client 150 also includes a memory 158 for storing data and program instructions. Although illustrated as a single memory 158, the memory 158 may be implemented as multiple memories in the client 150. The memory 158 may include any memory or database module and may take the form of volatile or non-volatile memory including, without limitation, magnetic media, optical media, random access memory (RAM), read-only memory (ROM), flash memory, removable media, or any other suitable local or remote memory component. The memory 158 may store various objects or data, including classes, widgets, frameworks, applications, backup data, business objects, jobs, Web pages, Web page templates, database tables, process contexts, repositories storing services local to the client 150, and any other appropriate information including any parameters, variables, database queries, algorithms, instructions, rules, constraints, or references thereto associated with the purposes of the client 150 and an associated client application 156 and/or ordering engine 166. In some implementations, including a cloud-based system, some or all of the memory 158 can be stored remote from the client 150, and communicably coupled to the client 150 for usage. As illustrated in FIG. 1, memory 158 includes an at least one ordering algorithm 162 instance, at least one layout grid 166 instance, at least one widget 168 instance, and at least one widget metadata 170 instance. Although not illustrated, the memory 158 may also store at least one business process instance, similar to its analogous counterpart stored in memory 112. The stored at least one business process instance may be a copies of and/or a reference to an analogous instance stored in memory 112.

The at least one ordering algorithm 164 instance may represent rules, criteria conditions, parameters, variables, instructions, constraints, references, queries, and any other appropriate information used to intuitively order widgets in a workspace. For example, one or more algorithms may intuitively order widgets in a workspace by alphanumeric arrangement, rank, suggestions (automatic or user), removing empty space to consolidate, removing widget overlap due to resizing and moving, etc. A user may also define custom ordering algorithms unique to the user's needs. In some implementations, the at least one ordering algorithm 164 can be stored remotely from the client 150. The at least one ordering algorithm 164 may be accessed, for example, via a Web service, a remote access system or software, a local or remote client 150, the client application 156, the business application 108, or other suitable example environment 100 component.

The at least one widget 168 instance may be similar to the at least one widget 115 instance of the server 102. The at least one widget 168 instance may represent a copy of the at least one widget 115 instance to process locally on client 150 or a reference to the at least one widget 115 instance on server 102.

The at least one widget metadata 170 instance may be similar to the at least one widget metadata 116 instance of the server 102. The at least one widget metadata 170 instance may represent a copy of the at least one widget metadata 116 instance to process locally on client 150 or a reference to the at least one widget metadata 116 instance on server 102.

The interface 160 of the client 150 may be similar to the interface 104 of the server 102, in that it may comprise logic encoded in software and/or hardware in a suitable combination and operable to communicate with the network 120. More specifically, interface 160 may comprise software supporting at least one communication protocol such that the network 120 or hardware is operable to communicate physical signals to and from the client 150. Further, although illustrated as a single interface 160, the interface 160 may be implemented as multiple interfaces in the client 150.

While FIG. 1 is described as containing or being associated with a plurality of components, not all components illustrated within the illustrated implementation of FIG. 1 may be utilized in each implementation of the present disclosure. Additionally, at least one component described herein may be located external to example environment 100, while in other implementations, certain components may be included within or as a portion of at least one described component, as well as other components not described. Further, certain components illustrated in FIG. 1 may be combined with other components, as well as used for alternative or additional purposes, in addition to those purposes described herein.

Initial Layout Grid Rendering/Subsequent User Actions

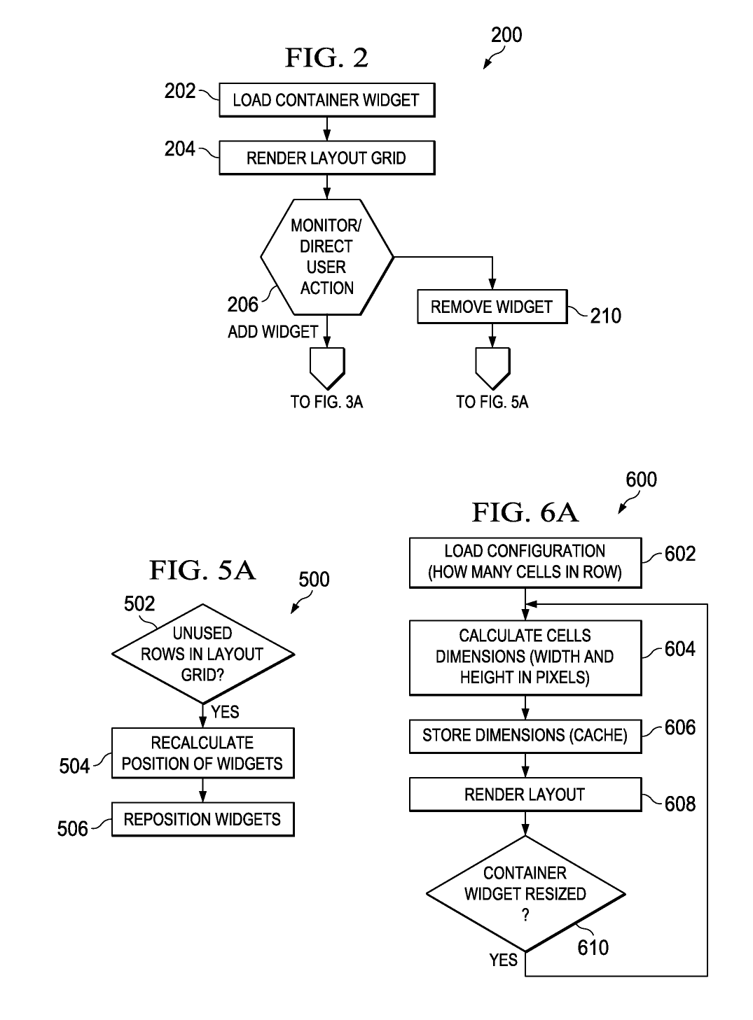

FIG. 2 is a flowchart illustrating an initial rendering of a layout grid and subsequent user actions. For clarity of presentation, the description that follows generally describes method 200 in the context of FIG. 1. However, it will be understood that method 200 may be performed, for example, by any other suitable system, environment, software, and hardware, or a combination of systems, environments, software, and hardware as appropriate.

Referring now to FIG. 2, method 200 begins at 202. At 202, a container widget is loaded. For example, a browser is opened on a computer desktop. In some implementations, the container widget instance object instance is copied from the server to the client. In other implementations, the container widget instance reference is copied from the server to the client and the container widget instance is processed on the server. Other implementations allow the container widget instance to reside in any suitable memory, whether local to or remote from example environment 100. From 202, method 200 proceeds to 204.

At 204, a layout grid is instantiated within the container widget. For example, the layout grid is instantiated within the browser. In some implementations, the layout grid is instantiated with a default granularity and number of columns and rows. In other implementations, the granularity and number of columns and rows are determined based upon metadata, such as the computer desktop widget resolution. In some implementations, the layout grid may be pre-populated with widgets. For example, the browser layout grid may have a clock widget, a weather widget, and a security widget pre-populated to render when the browser loads. From 204, method 200 proceeds to 206.

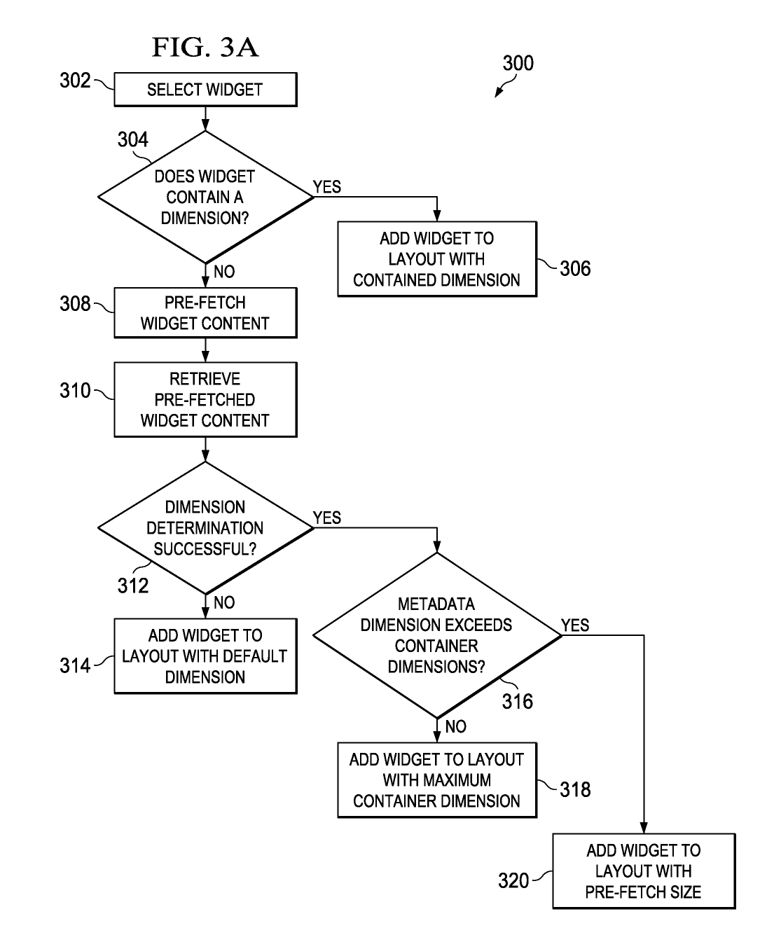

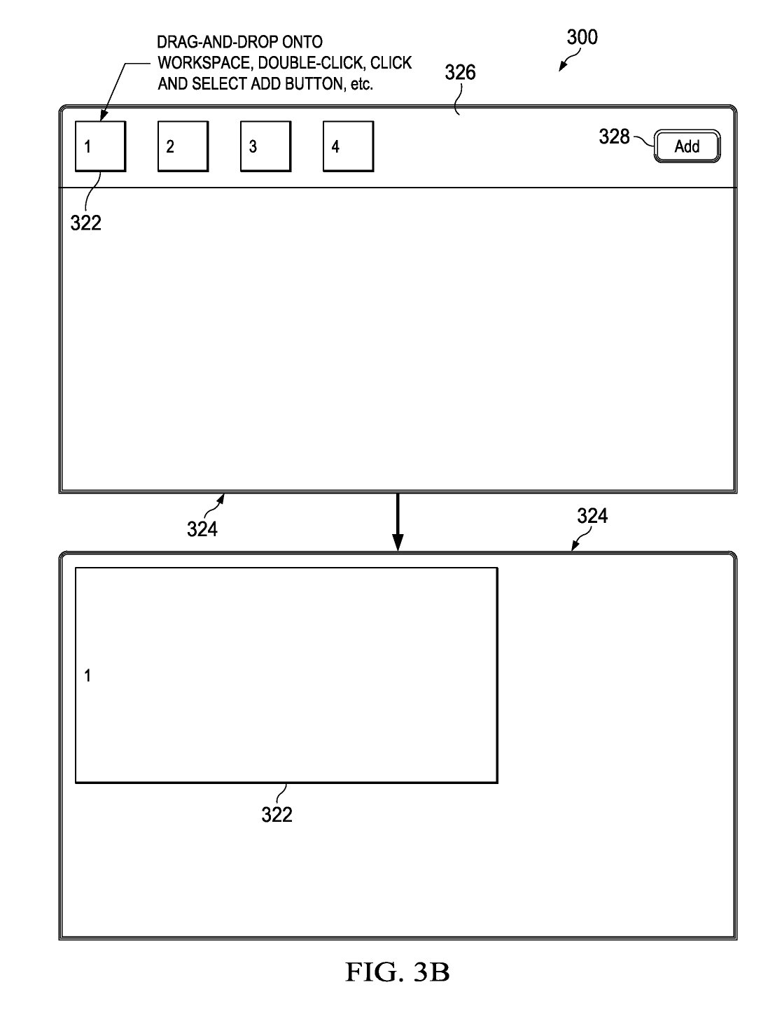

At 206, the container widget monitors for an indication of a user action. In some implementations, some other widget, software, or hardware may monitor for the user action and pass a notification to the container widget once the user action is determined. Although illustrated to monitor and direct adding and/or removing a widget from the layout grid, other user actions consistent with this application may be monitored and directed. For example, moving a widget, resizing a widget, etc. If at 206, the user action is to add a widget to the grid layout, method 200 optionally performs the functionality described below with respect to FIG. 3A. If at 206, however, the user action is to remove a widget from the layout grid, method 200 proceeds to 210.

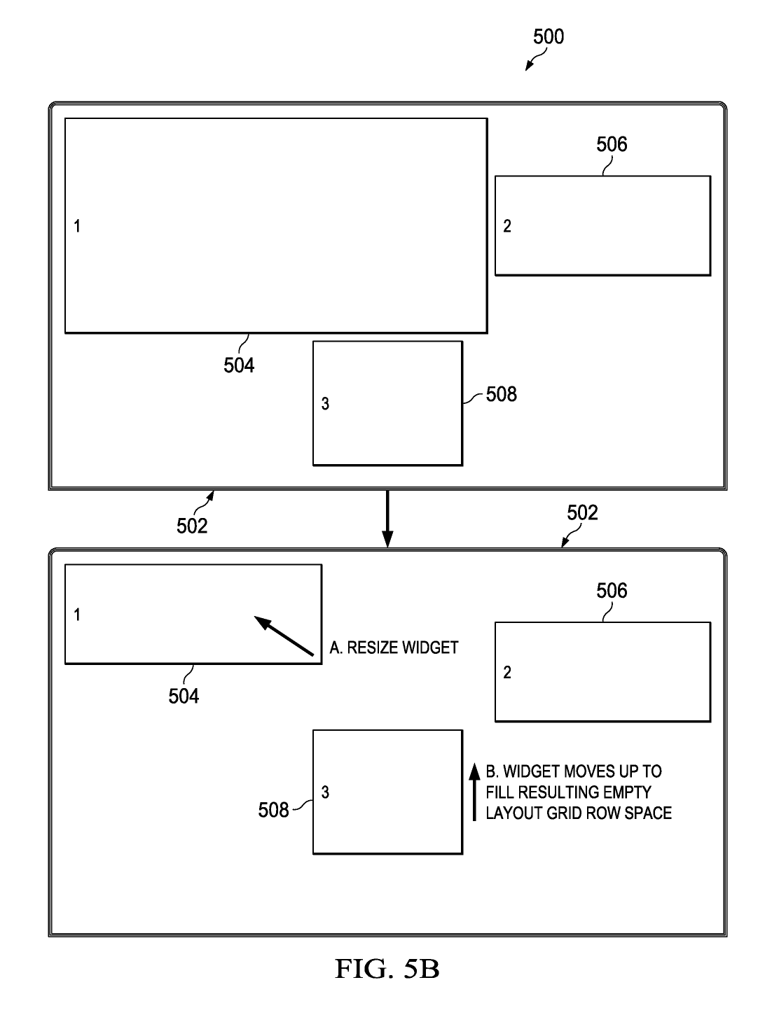

At 210 a widget is removed from the container widget. For example, a user may have a clock widget in a workspace and decide to replace it with another type of clock widget. The user then uses the GUI to remove the clock widget from the container widget. After the removal of the widget from the container widget, there may be unused rows in the layout grid. From 210, method 200 optionally performs the functionality described below with respect to FIG. 5A.

Widget Pre-Fetch

FIG. 3A is a flowchart illustrating a pre-fetching function for a widget. For clarity of presentation, the description that follows generally describes method 300 in the context of FIG. 1. However, it will be understood that method 300 may be performed, for example, by any other suitable system, environment, software, and hardware, or a combination of systems, environments, software, and hardware as appropriate.

Referring now to FIG. 3, method 300 begins at 302. At 302, a widget is selected for inclusion into a container widget workspace. In some implementations, the widget is selected from a GUI element presenting a list of widgets and/or elements such as buttons, radio boxes, pull-down menus, etc. In some implementations, selecting can be performed using, for example, a computer mouse, keyboard, stylus, touch screen, an algorithm, voice recognition or other suitable selection method and/or tool. The selecting action may also include a click, double click, drag-and-drop, or other suitable section action. In some implementations, an outline, wireframe, or other indication of the dimension determined below can be initially displayed on a GUI to indicate to a user the dimension the selected widget will assume in the container widget workspace. This displayed dimensional indication may allow the user to more efficiently position the widget within the container widget workspace. From 302, method 300 proceeds to 304.

At 304, a determination is made whether the loaded widget contains a dimension. In some implementations, the dimension can be retrieved from metadata associated with the widget. If it is determined that the widget contains a dimension, method 300 proceeds to 306. At 306, the widget is added to a layout grid associated with the container widget according to the contained dimension and the content associated with the widget is retrieved. In some implementations, the content may be retrieved from the client, the server or the third-party content provider to display within the widget. After 306, method 300 stops. If at 304, however, it is determined that the widget did not contain a dimension, method 300 proceeds to 308.

At 308, the loaded widget is pre-fetched from either the server memory and/or the client memory. From 308, method 300 proceeds to 310.

At 310, the content associated with the pre-fetched widget is retrieved as discussed above in 306. From 310, method 300 proceeds to 312.

At 312, a determination is made whether a prediction of the pre-fetched widget dimension may be made. For example, if the retrieved pre-fetch widget content contains an image of 300×300 pixels, the ordering engine could determine that a dimension of 300×300 pixels is appropriate for the pre-fetched widget. The predictive determination of the widget dimension may be made with various algorithms and content data types as would be apparent to one of ordinary skill in the art. If at 312, it is determined that a dimension prediction for the pre-fetched widget could not made, the method 300 proceeds to 314. At 314, the pre-fetched widget is added to the layout grid with a default dimension and the content associated with the widget is retrieved as discussed above in 306. In some implementations, the default dimension may be user defined or automatically determined by the ordering engine. After 314, method 300 stops. If at 312, however, it is determined that the pre-fetched widget contained a dimension, method 300 proceeds to 316.

At 316, a determination is made whether the determined dimension for the pre-fetched widget exceeds the container metadata dimension. For example, if the determined dimension of the pre-fetched widget is 300×300 pixels and the dimension of the container widget is 250×300 pixels. If at 312, it is determined that the metadata dimension does not exceed the container metadata dimension, method 300 proceeds to 318. At 318, the pre-fetched widget is added to the layout grid with the maximum container dimension and the content associated with the pre-fetched widget is retrieved as discussed above in 306. For example, if the determined dimension of the pre-fetched widget is 300×300 pixels and the dimension of the container widget is 1900×1080 pixels, the pre-fetched widget is added to the layout grid with a dimension of 1900×1080 pixels. After 318, method 300 stops. If at 316, however, it is determined that the metadata dimension does exceed the container metadata dimension, method 300 proceeds to 320. At 320, the widget is added to the layout grid with the pre-fetch dimension and the content associated with the pre-fetched widget is retrieved as discussed above in 306. For example, if the determined dimension of the pre-fetched widget is 300×300 pixels and the dimension of the container widget is 250×300 pixels, the pre-fetched widget is added to the layout grid with a dimension of 250×300 pixels. After 320, method 300 stops.

FIG. 3B is a block diagram illustrating the selection and addition of a widget to a container widget. Widget 322 and other available widgets are illustrated within a GUI element 326 along with an “Add” button 328. The GUI element 326 is associated with the container widget 324. In this example, the user selects widget 322 with a double-click using a computer mouse. Following the selection of widget 322, the GUI element 326 is hidden from view and widget 322 is shown added to the container widget 324. In this example, the widget 322 contained a dimension specifying a dimension smaller than the dimension of the container widget 324.

Overlapping Widgets

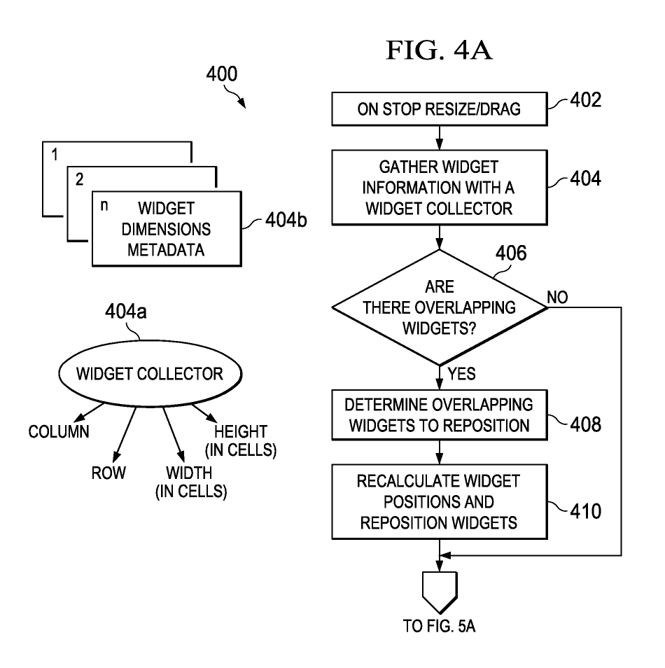

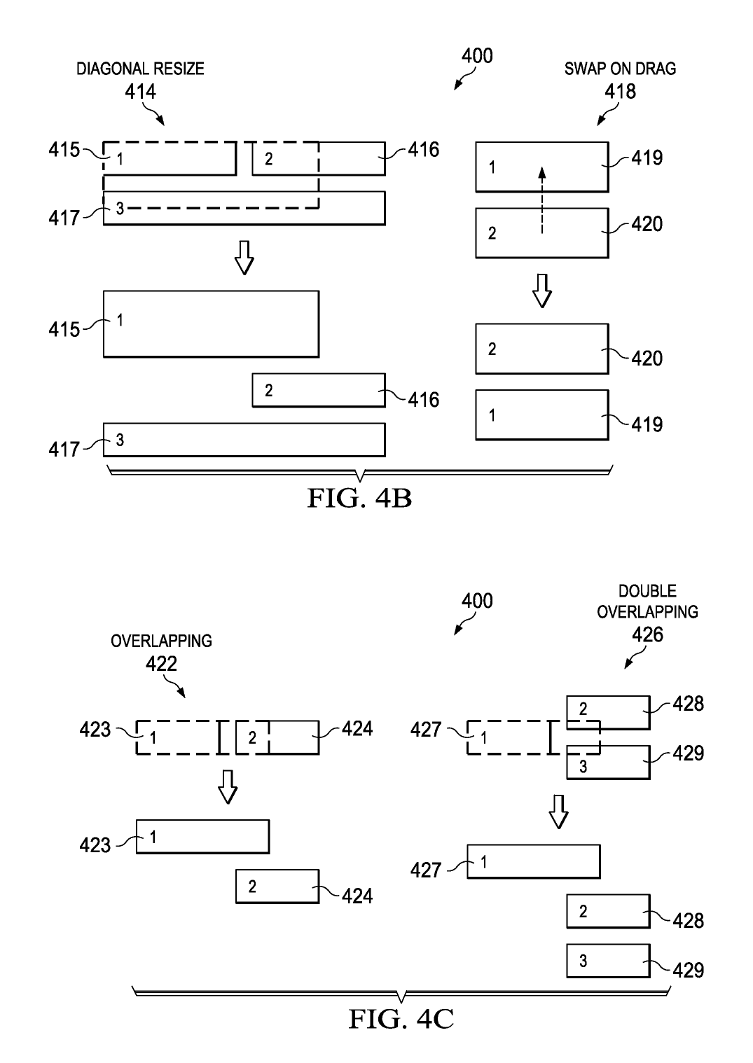

FIG. 4A is a flowchart illustrating functionality to handle overlapping widgets. For clarity of presentation, the description that follows generally describes method 400 in the context of FIG. 1 and FIGS. 4B-4C. However, it will be understood that method 400 may be performed, for example, by any other suitable system, environment, software, and hardware, or a combination of systems, environments, software, and hardware as appropriate.

Referring now to FIG. 4A, method 400 begins at 402. At 402, on stop of a resize or drag operation on a widget within a container widget, method 400 proceeds to 404. For example, a user may have dragged a widget from one location within the container widget and dropped it at another location that overlaps another widget's position. In another example, a user may have resized a widget where the resized widget overlaps another widget's position.

At 404, a widget collector 404a gathers information about all widgets in the current layout grid (e.g., position by column and row and width and height in layout grid cells). In some implementations, the widget collector 404a can access each widget's metadata 404b and retrieve dimension metadata. In other implementations, the widget collector 404a can determine the widget dimension in some other manner, such as using predictive analysis based upon content or some other suitable method consistent with this disclosure. In some implementations, the widget collector 404a can be an individual application, program, module, process, or other software that implements the various features and functionality through various objects, methods, or other processes. The widget collector 404a may also include a number of sub-modules, third-party services, components, libraries, and such, as appropriate. After 404, method 400 proceeds to 406.

At 406, a determination is made whether there are overlapping widgets. In some implementations, this determination is made by the ordering engine. If it is determined that there are overlapping widgets, method 400 proceeds to 408. At 408, the overlapped widgets to be repositioned are identified. Method 400 then proceeds to 410. If at 406, however, it is determined that there are no overlapping widgets, method 400 optionally performs the functionality described below with respect to FIG. 5A.

At 410, the overlapped widget's positions are recalculated and the overlapped widgets are repositioned within the containing widget to eliminate any widget position overlap. In some implementations, both the overlapping widget and the overlapped widgets may be repositioned. In some implementations, the recalculation of widget positions can be performed recursively. The present disclosure also contemplates recalculation of the overlapping widget positions by any suitable method. From 410, method 400 optionally performs the functionality described below with respect to FIG. 5A.

FIGS. 4B-4C are block diagrams illustrating example widget overlap scenarios handled by an overlapping widget organizer function. Turning now to FIG. 4B, FIG. 4B illustrates a diagonal resize scenario 414 and a swap on drag scenario 418. In the diagonal resize scenario 414, a user is attempting to resize widget 415 where the resized widget 415 will overlap widget 416 and widget 417. On the completion of the resize of widget 415, widgets 415, 416, and 417 are determined to be overlapping. As widget 415 was resized, its dimension and position is not affected further. Widgets 416 and 417 have new positions calculated for them and are repositioned within the container widget to eliminate the overlap of the widgets. While the diagonal resize scenario 414 illustrates repositioning widgets vertically downward to eliminate overlap, the present disclosure contemplates repositioning overlapping widgets in many possible orientations.

In the swap on drag scenario 418, a user is attempting to drag widget 420 over the position of widget 419. On the completion of the drag-and-drop of widget 420, widgets 419 and 420 are determined to be overlapping. As widget 420 was moved, its dimension and position is not affected further. Widget 419 has a new position calculated for it and is repositioned by swapping with the original position of widget 420 to eliminate the overlap of the widgets. While the swap on drag scenario 418 illustrates repositioning a widget vertically downward to eliminate overlap, the present disclosure contemplates repositioning overlapping widgets in many possible orientations.

Turning now to FIG. 4C, FIG. 4C illustrates an overlapping scenario 422 and a double overlapping scenario 426. In the overlapping scenario 422, a user is attempting to resize widget 423 where the resized widget 423 will overlap widget 424. On the completion of the resize of widget 423, widgets 423 and 424 are determined to be overlapping. As widget 423 was resized, its dimension and position is not affected further. Widget 424 has a new position calculated for it and is repositioned within the container widget to eliminate the overlap of the widgets. While the overlapping scenario 422 illustrates repositioning a widget vertically downward to eliminate overlap, the present disclosure contemplates repositioning overlapping widgets in many possible orientations.

In the double overlapping scenario 426, a user is attempting to resize widget 427 to a dimension overlapping the position of both widget 428 and widget 429. On the completion of the resize of widget 427, widgets 427, 428, and 429 are determined to be overlapping. As widget 427 was resized, its dimension and position is not affected further. Widgets 428 and 429 have new positions calculated for them and are repositioned by vertically repositioning widget 428 and widget 429 vertically downward to eliminate the overlap of the widgets. While the double overlapping scenario 426 illustrates repositioning widgets vertically downward to eliminate overlap, the present disclosure contemplates repositioning overlapping widgets in many possible orientations.

Remove Empty Rows Between Widgets

FIG. 5A is a flowchart illustrating the functionality to remove empty grid row space between widgets in a container widget. For clarity of presentation, the description that follows generally describes method 500 in the context of FIG. 1. However, it will be understood that method 500 may be performed, for example, by any other suitable system, environment, software, and hardware, or a combination of systems, environments, software, and hardware as appropriate.

Referring now to FIG. 5A, method 500 begins at 502. At 502, a determination is made whether there is unused layout grid row space between widgets. If it is determined that there are unused rows in the layout grid within the container widget, method 500 proceeds to 504. At 504, widget positions are recalculated to account for removed empty layout grid rows. After 504, method 500 proceeds to 506.

At 506, widgets in the container widget are repositioned. After 506, method 500 stops.

FIG. 5B is a block diagram illustrating the removal of empty layout grid row space between widgets. Widgets 504, 506, and 508 are shown within container widget 502. In this example, the user selects, as discussed above in 302, widget 504 to be resized to a smaller dimension within container widget 502. Following the resizing of widget 504, a determination is made as to whether there are unused rows between the bottom of widgets 504 and 506. As widget 508 is the bottommost widget, whether it has unused layout grid row space below it is immaterial. Due to the resize of widget 504 however, unused layout grid row space is left between the bottommost edge of widget 506 and the topmost edge of widget 508. Widget 508 is then moved up vertically to reduce the distance between the bottommost edge of widget 506 and the topmost edge of widget 508. In some implementations, the determination of how much layout grid row space triggers this functionality is user defined, automatically determined by the ordering engine and/or the ordering algorithms, or by some other suitable method consistent with this disclosure.

Resizing a Container Widget

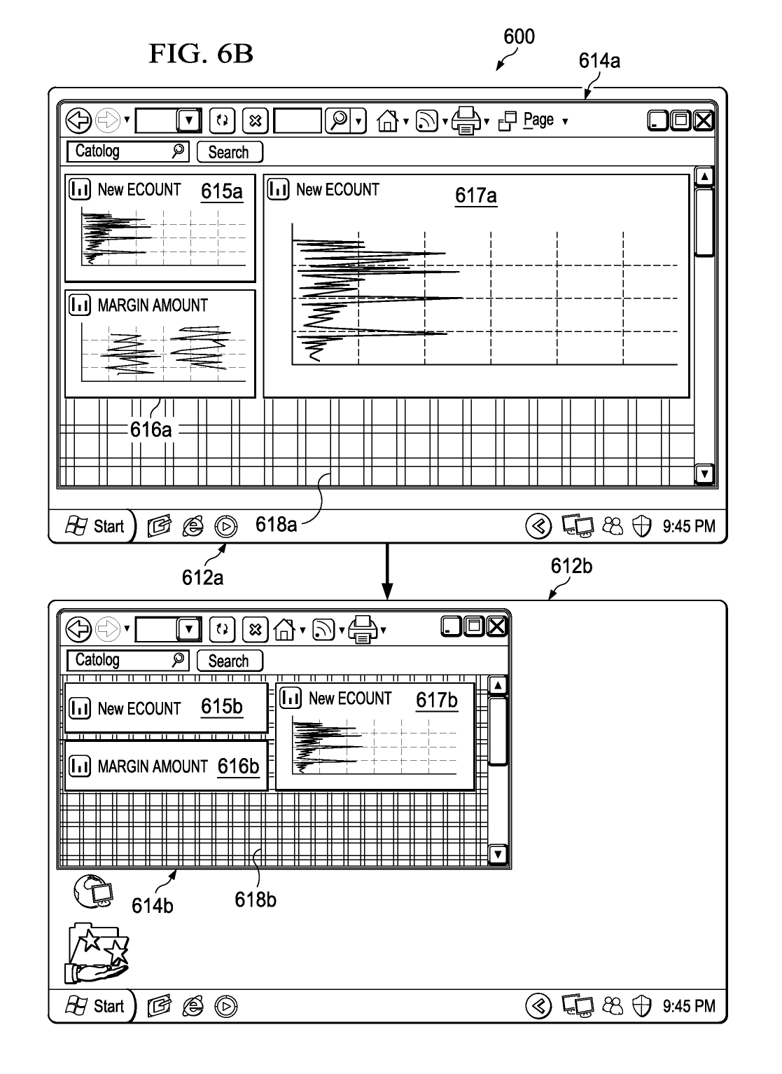

FIG. 6 is flow chart illustrating functionality for modifying the layout grid in a container widget when the container widget is resized. For clarity of presentation, the description that follows generally describes method 600 in the context of FIG. 1. However, it will be understood that method 600 may be performed, for example, by any other suitable system, environment, software, and hardware, or a combination of systems, environments, software, and hardware as appropriate.

Referring now to FIG. 6, method 600 begins at 602. At 602, initially, the the number of cells in a row in a container widget is determined. In some implementations, the determination of the number of cells in a layout grid row is performed by retrieving layout grid metadata for the container widget. Method 600 proceeds to 604.

At 604, dimensions for each cell are calculated using the width and height of the resized container widget in order to preserve the determined number of cells in the layout grid row. In some implementations, the width and height in pixels is used. In other implementations, a measurement other than width and height in pixels can be used. Method 600 proceeds to 606.

At 606, the calculated cell dimensions are cached. In some implementations, the calculated cell dimensions are cached in metadata. Method 600 proceeds to 608.

At 608, the layout grid is rendered within the container widget consistent with the calculated cell dimensions (i.e., a granularity modification). Note that all widgets in the layout grid are also dimensioned to remain within the visible portion of the container widget. On a resize of the container widget, widgets are re-dimensioned to conform to the newly resized container widget. In some implementations, a minimum threshold can be established for the rendered dimension of displayed widgets. Beyond the minimum threshold, displayed widgets may be reduced to icons, symbols, phrases, or other suitable representations of the widget. After 610, method 600 proceeds to 610.

At 610, a determination is made if the container widget was resized. If it is determined that the container widget was resized, method 600 proceeds to 604 as described above to recalculate the dimensions of the layout grid cells based upon the new dimension of the container widget.

FIG. 6B is block diagram illustrating modifying the grid layout in a container widget when the container widget is resized. On computer desktop 612a, widgets 615a, 616a, and 617a are shown arranged on a layout grid 618a within a container widget 614a (a browser). In this example, the user resizes container the widget 614a as shown on computer desktop 612b. Following the resizing of the containing widget 614a to the dimensions of containing widget 614b, the number of cells in a row of the layout grid 618a are determined and cell dimensions are recalculated based upon the resized dimension of containing widget 614b. The recalculated cell dimensions are reflected in layout grid 618b as shown in computer desktop 612b. Widgets 615b, 616b, and 617b are shown resized on newly calculated layout grid 618b within a container widget 614b. In some implementations, each resized widget in a resized container widget will retain their orientation relative to other resized widgets, the relative orientation being the same as the orientation prior to the resize of the container widget.

Maximize a Widget Within a Container Widget

FIG. 8 is a block diagram illustrating the maximization of a widget within a container widget. Widgets 804, 806, and 808 are shown within container widget 802. In this example, the user selects, as discussed above in 302, widget 808 to be maximized within container widget 802. Following the selection of widget 808 to be maximized, the widgets 804 and 806 are reduced in size and aligned along the left side of container widget 808, while widget 808 is increased in dimension to fill the remaining space in container widget 802 minus the area reserved in the container widget 802 to hold the representations of widgets 804 and 806. In some implementations, the non-maximized widgets may be arranged in various manners (e.g., sorted by alphanumeric, timestamp, etc.), made hidden but accessible, placed on a GUI menu item, or other suitable method to allow the selected widget to increase in size as compared to the non-maximized widgets. In some implementations, selecting a non-maximized widget, for example by a single click with a computer mouse, will present its maximized form within container widget 802 and swap a currently maximized widget into its place within the container widget. In this way, a user may cycle through and view all widgets in a maximized format. In some implementations, selecting a currently maximized widget, for example by a double-click with a computer mouse, will result in all widgets returning to their original states and locations. Other similar functionality may also be implemented consistent with this disclosure.

In some implementations, non-maximized widgets and/or content can be reduced to smaller representative versions of themselves, for example to fit into a single layout grid cell or a determined number of cells of the containing widget layout grid. In other words, the entire widget, possibly including content, will be reduced in dimension and placed into a position in the container widget (i.e., the granularity of the non-maximized widget is changed). In some implementations, this determination is made by the ordering engine and/or ordering algorithms. In other implementations, the widget itself may not be reduced in size but a portion of the widget of the same dimension above, for example of a single cell or of a determined number of cells, may be excised from a widget and be used to represent a non-maximized widget (i.e., the granularity of the non-maximized widget is preserved). For example, if a widget had a title bar with the words “HI-TECH Calculator” and a representative non-maximized widget is only 50×50 pixels, if the entire widget is reduced (granularity is changed), the title bar words would all be visible in the reduced widget but rendered extremely small. If, however, only a portion of the widget were used (i.e., granularity of the non-maximized widget is preserved), the representative portion of the non-maximized widget may only have “Hi-Tech” displayed along with the widget portion content that fits within the specified dimension. In some implementations, the granularity setting may be user-selectable, automatically selected by the ordering engine and/or ordering algorithms, or by some other suitable method.

The preceding figures and accompanying description illustrate example processes and computer implementable techniques. But example environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, in parallel, and/or in combination. In addition, many of the steps in these processes may take place simultaneously, concurrently, in parallel, and/or in different orders than as shown. Moreover, example environment 100 may use processes with additional steps, fewer steps, and/or different steps, so long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A computer-implemented method for intuitive widget ordering in a workspace, comprising:
loading a container widget;
rendering, using at least one computer, a layout grid associated with the loaded container widget; and
receiving an action associated with the container widget.

2. The computer-implemented method of claim 1, wherein the layout grid is within the container widget.

3. The computer-implemented method of claim 1, wherein the layout grid includes at least one row and at least one column and the intersection of the at least one row and the at least one column includes at least one cell.

4. The computer-implemented method of claim 3, wherein a gap space exists between the at least one row boundary and the at least one column boundary.

5. The computer-implemented method of claim 1, wherein the granularity of the layout grid is based upon metadata.

6. The computer-implemented method of claim 1, further comprising adding a widget to the container widget.

7. The computer-implemented method of claim 6, wherein the added widget interacts at least dimensionally with the layout grid.

8. The computer-implemented method of claim 1, further comprising removing a widget from the container widget.

9. The computer-implemented method of claim 8, further comprising removing unused rows in the layout grid after removing the widget from the container widget.

10. The computer-implemented method of claim 8, wherein the removing unused rows comprises:
determining whether there are unused rows in the layout grid;
recalculating new positions of other widgets in the layout grid; and
repositioning the other widgets.

11. A computer-program product for intuitive widget ordering in a workspace, the computer program product comprising computer-readable instructions embodied on tangible, non-transitory media, the instructions operable when executed to:
load a container widget;
render, using at least one computer, a layout grid associated with the loaded container widget; and
receive an action associated with the container widget.

12. The computer-program product of claim 11, wherein the layout grid is within the container widget.

13. The computer-program product of claim 11, wherein the layout grid includes at least one row and at least one column and the intersection of the at least one row and the at least one column includes at least one cell.

14. The computer-program product of claim 13, wherein a gap space exists between the at least one row boundary and the at least one column boundary.

15. The computer-program product of claim 11, wherein the granularity of the layout grid is based upon metadata.

16. The computer-program product of claim 11, further comprising adding a widget to the container widget.

17. The computer-program product of claim 16, wherein the added widget interacts at least dimensionally with the layout grid.

18. The computer-program product of claim 11, further comprising removing a widget from the container widget.

19. The computer-program product of claim 18, further comprising removing unused rows in the layout grid after removing the widget from the container widget.

20. The computer-program product of claim 18, wherein the removing unused rows comprises:
determining whether there are unused rows in the layout grid;
recalculating new positions of other widgets in the layout grid; and
repositioning the other widgets.

21. A system for intuitive widget ordering in a workspace, comprising:
memory operable to store a container widget; and
at least one hardware processor interoperably coupled to the memory and operable to:
load the container widget;
render, using at least one computer, a layout grid associated with the loaded container widget; and
receive an action associated with the container widget.

22. The system of claim 21, wherein the layout grid is within the container widget.

23. The system of claim 21, wherein the layout grid includes at least one row and at least one column and the intersection of the at least one row and the at least one column includes at least one cell.

24. The system of claim 23, wherein a gap space exists between the at least one row boundary and the at least one column boundary.

25. The system of claim 21, wherein the granularity of the layout grid is based upon metadata.

26. The system of claim 21, further comprising adding a widget to the container widget.

27. The system of claim 26, wherein the added widget interacts at least dimensionally with the layout grid.

28. The system of claim 21, further comprising removing a widget from the container widget.

29. The system of claim 28, further comprising removing unused rows in the layout grid after removing the widget from the container widget.

30. The system of claim 28, wherein the removing unused rows comprises:
determining whether there are unused rows in the layout grid;
recalculating new positions of other widgets in the layout grid; and
repositioning the other widgets.
